(19) United States
(12) Patent Application Publication
(10) Pub. No.: US 2026/0268771 A1
(43) Pub. Date: Sep. 10, 2026

(54) PARKING ASSISTANCE APPARATUS

(71) Applicant: TOYOTA JIDOSHA KABUSHIKI KAISHA, Aichi (JP)

(72) Inventor: Keisuke OYAMA, Nisshin-shi (JP)

(21) Appl. No.: 19/553,430

(22) Filed: Mar. 2, 2026

(30) Foreign Application Priority Data
Mar. 7, 2025 (JP) 2025-036339

(51) Int. Cl. G08G 1/14; B60K 35/22; B60K 35/28

(52) U.S. Cl. CPC G08G 1/143; B60K 35/22; B60K 35/28; B60K 2360/162

(57) ABSTRACT

The present disclosure provides a parking assistance apparatus for effectively improve operability of a use-start switch. The apparatus includes a control unit capable of executing parking assistance control that assists at least part of driving operations by parking a vehicle in a predetermined parking space, and a visualization processing unit configured to execute visualization processing that visualizes a use-start switch by displaying or illuminating the use-start switch for receiving a request from an occupant of the vehicle to start the parking assistance control. The visualization processing unit visualizes the use-start switch by executing the visualization processing when the control unit recognizes, as the parking space, a parkable space in which the vehicle can be parked by the parking assistance control, and does not visualize the use-start switch by hiding or turning off the use-start switch when the control unit does not recognize the parkable space.

### CROSS-REFERENCE TO RELATED APPLICATION

This application claims priority to Japanese Patent Application No. JP 2025-036339 filed on Mar. 7, 2025, the content of which is hereby incorporated by reference in its entirety into this application.

### BACKGROUND OF THE INVENTION

### 1. Field of the Invention

The present disclosure relates to a parking assistance apparatus.

### 2. Description of the Related Art

For example, Japanese Patent Application Laid-Open (kokai) No. 2006-321336 discloses a vehicle switch apparatus in which a decorative panel having a woodgrain pattern or the like applied thereto for vehicle interior use is illuminated by a light source from a rear side of the decorative panel to display a predetermined graphic on a front side of the decorative panel, and electrodes are arranged on a rear side at a position where the graphic of the decorative panel is displayed.

In the switch apparatus described in Patent Document 1, for example, when an occupant touches an electrode arrangement position of the decorative panel, an operation of an in-vehicle device corresponding thereto is executed. Further, in the switch apparatus described in Patent Document 1, when the light source is turned on, the graphic is displayed, and when the light source is turned off, the graphic disappears and only the woodgrain pattern appears. That is, by suppressing visual complexity, an improvement in design aesthetics is achieved.

However, in the switch apparatus described in Patent Document 1, since a graphic functioning as a switch is not displayed when the switch is not being operated, the occupant cannot normally visually recognize the graphic. For this reason, when the occupant actually attempts to operate the switch, the position of the graphic is difficult to recognize, resulting in a problem that switch operation is difficult. That is, it can be said that there is room for improvement in operability.

### SUMMARY OF THE INVENTION

The present disclosure has been made in order to solve the above-described problem, and an object thereof is to effectively improve operability of a use-start switch in a driving assistance apparatus.

The technology of the present disclosure provides a parking assistance apparatus comprising
a control unit capable of executing parking assistance control that assists at least part of driving operations by parking a vehicle in a predetermined parking space,
the parking assistance apparatus comprising
a visualization processing unit configured to execute visualization processing that visualizes a use-start switch by displaying or illuminating the use-start switch for receiving a request from an occupant of the vehicle to start the parking assistance control,
wherein the visualization processing unit
visualizes the use-start switch by executing the visualization processing when the control unit recognizes, as the parking space, a parkable space in which the vehicle can be parked by the parking assistance control, and
does not visualize the use-start switch by hiding or turning off the use-start switch when the control unit does not recognize the parkable space.

### BRIEF DESCRIPTION OF THE DRAWINGS

FIG. 1 is a schematic diagram illustrating a hardware configuration of a vehicle according to the present embodiment.

FIG. 2 is a schematic diagram illustrating a software configuration of a control device according to the present embodiment.

FIG. 3A is a schematic diagram for explaining modes of visualization processing of a use-start switch according to the present embodiment.

FIG. 3B is a schematic diagram for explaining modes of visualization processing of a use-start switch according to the present embodiment.

FIG. 3C is a schematic diagram for explaining modes of visualization processing of a use-start switch according to the present embodiment.

FIG. 4 is a flowchart for explaining a flow of parking assistance control and visualization processing of the use-start switch according to the present embodiment.

### DESCRIPTION OF THE EMBODIMENTS

Hereinafter, a parking assistance apparatus according to the present embodiment will be described with reference to the drawings.

### Hardware Configuration

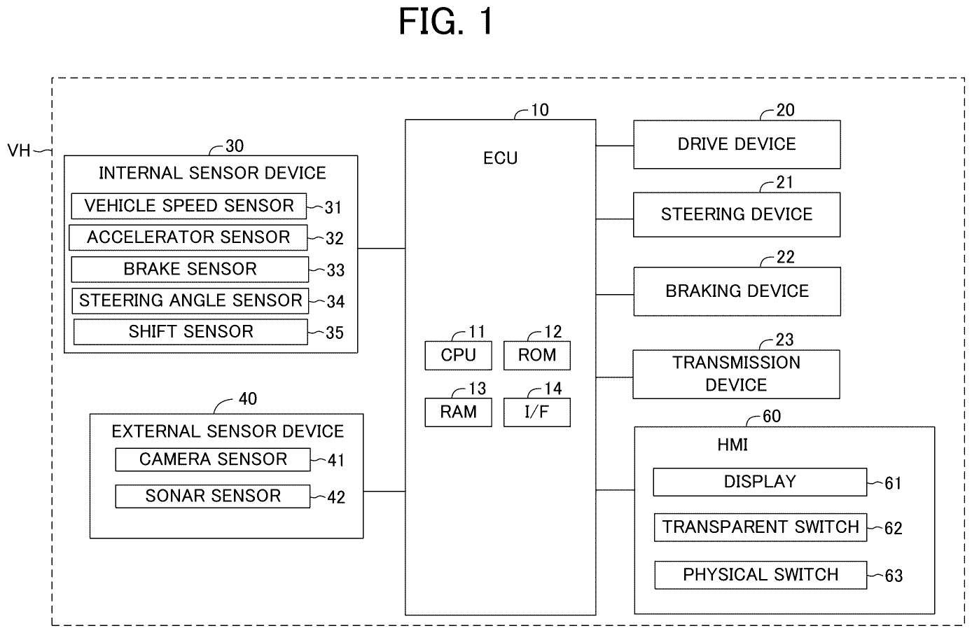

FIG. 1 is a schematic diagram illustrating a hardware configuration of a vehicle VH according to the present embodiment. Hereinafter, the vehicle VH may be referred to as an own vehicle when it is necessary to distinguish it from other vehicles and the like.

The vehicle VH includes an ECU (Electronic Control Unit) 10. The ECU 10 includes a CPU (Central Processing Unit) 11, a ROM (Read Only Memory) 12, a RAM (Random Access Memory) 13, an interface device 14, and the like. The CPU 11 is a processor that executes various programs stored in the ROM 12. The ROM 12 is a non-volatile memory that stores data and the like necessary for the CPU 11 to execute various programs. The RAM 13 is a volatile memory that provides a work area in which various programs are expanded when executed by the CPU 11. The interface device 14 is a communication device for communicating with external devices.

The ECU 10 is a central device that performs driving assistance such as parking assistance control of the vehicle VH. Driving assistance is a concept that includes automated driving. The ECU 10 is communicably connected to a drive device 20, a steering device 21, a braking device 22, a transmission device 23, an internal sensor device 30, an external sensor device 40, an HMI 60, and the like.

The drive device 20 generates driving force to be transmitted to drive wheels of the vehicle VH. Examples of the drive device 20 include an electric motor and an engine. The steering device 21 applies steering force to wheels of the vehicle VH. The braking device 22 applies braking force to wheels of the vehicle VH. The transmission device 23 decelerates rotational power output from the drive device 20 at a predetermined gear ratio and transmits the rotational power to the drive wheels.

The internal sensor device 30 includes sensors for acquiring a running state of the vehicle VH. The internal sensor device 30 includes a vehicle speed sensor 31, an accelerator sensor 32, a brake sensor 33, a steering angle sensor 34, a shift sensor 35, and the like.

The vehicle speed sensor 31 detects a traveling speed (vehicle speed) of the vehicle VH. The accelerator sensor 32 detects an operation amount of an accelerator pedal (not illustrated) operated by a driver. The brake sensor 33 detects an operation amount of a brake pedal (not illustrated) operated by the driver. The steering angle sensor 34 detects a rotation angle (steering angle) of a steering wheel or a steering shaft (not illustrated). The shift sensor 35 detects a shift position (parking P, reverse R, neutral N, drive D, and the like) of the transmission device 23. The internal sensor device 30 transmits the running state of the vehicle VH detected by the sensors 31 to 35 to the ECU 10 at predetermined intervals.

The external sensor device 40 includes sensors that recognize object information regarding objects (surrounding objects) present around the vehicle VH. The external sensor device 40 includes, for example, a camera sensor 41 and a sonar sensor 42. Here, examples of the object information include parking spaces such as white lines drawn on a road surface, other vehicles, pedestrians, walls, poles, and the like.

The camera sensor 41 is, for example, a stereo camera or a monocular camera, and may be a digital camera having an imaging element such as a CMOS or CCD. The camera sensor 41 captures images of surroundings of the vehicle VH, and acquires object information regarding surrounding objects by processing the captured image data. The object information is information indicating a type of a surrounding object, a relative distance between the vehicle VH and the surrounding object, a relative speed between the vehicle VH and the surrounding object, and the like. The type of the surrounding object may be recognized by machine learning such as pattern matching, for example. In the present embodiment, the camera sensor 41 includes, for example, a front camera sensor, a rear camera sensor, a left-side camera sensor, and a right-side camera sensor.

The sonar sensor 42 emits ultrasonic waves into a predetermined range around the vehicle VH. A sonar sensor 43 receives reflected waves reflected by surrounding objects present within an emission range of the ultrasonic waves, and detects presence or absence of surrounding objects and a distance between the vehicle VH and the surrounding objects based on a time from transmission to reception of the ultrasonic waves. By emitting ultrasonic waves having high directivity, the sonar sensor 42 can detect surrounding objects located substantially in front thereof. In the present embodiment, the sonar sensor 42 includes, for example, a pair of left and right front sonar sensors, a pair of left and right front-side sonar sensors, a pair of left and right rear sonar sensors, a pair of left and right rear-side sonar sensors, a pair of front and rear left-side sonar sensors, and a pair of front and rear right-side sonar sensors.

The external sensor device 40 repeatedly transmits acquired object information to the ECU 10 every time a predetermined time has elapsed. Note that the external sensor device 40 does not necessarily need to include both the camera sensor 41 and the sonar sensor 42, and may include only the camera sensor 41, for example. Further, the external sensor device 40 may include a radar sensor.

The HMI 60 is an interface for inputting and outputting information between the ECU 10 and an occupant (mainly a driver) of the vehicle VH, and includes an input device and an output device. Examples of the input device include a touch-panel display 61, a transparent switch 62, a physical switch 63, a voice input microphone, and the like. Examples of the output device include the display 61 and a speaker. The display 61 is, for example, a center display installed in an instrument panel or the like, or a display of a navigation system. The transparent switch 62 is a switch in which a switch graphic is displayed on a front side of a panel by turning on a light source from a rear side of a light-transmissive panel installed in an instrument panel or the like, and electrodes are arranged on a rear side at a position where the switch graphic is displayed. The physical switch 63 is, for example, a push-button type switch provided on an instrument panel or a center console.

### Software Configuration

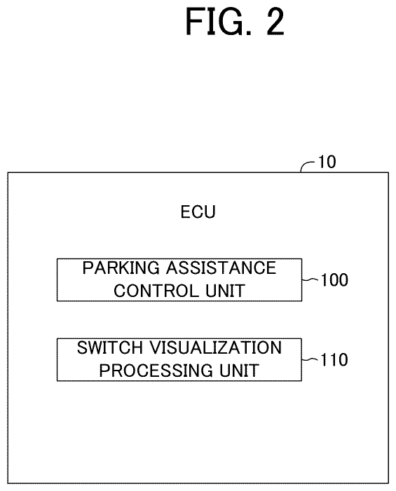

FIG. 2 is a schematic diagram illustrating a software configuration of a control device according to the present embodiment.

As illustrated in FIG. 2, the ECU 10 includes, as functional elements, a parking assistance control unit 100, a switch visualization processing unit 110, and the like. Each of these functional elements 100 and 110 is implemented by the CPU 11 of the ECU 10 reading programs stored in the ROM 12 into the RAM 13 and executing the programs. Note that all or part of the functional elements 100 and 110 may be provided in another ECU separate from the ECU 10, or in an information processing device of a facility (such as a management center) communicable with the vehicle VH.

The parking assistance control unit 100 executes parking assistance control for automatically parking the vehicle VH in a predetermined parking space. When the vehicle VH travels at a predetermined vehicle speed (for example, a low speed), the parking assistance control unit 100 searches, based on detection results of the external sensor device 40, for a parking space around the vehicle VH in which the vehicle VH can be parked (hereinafter referred to as a “parkable space”). Here, the parkable space refers to an area in which the vehicle VH can be parked by at least one of parallel parking and perpendicular parking. The parkable space includes not only areas partitioned by white lines, but also areas partitioned by structures such as walls or poles.

When the parking assistance control unit 100 recognizes a parkable space, the parking assistance control unit 100 sets a target travel route for parking the vehicle VH in the parkable space based on detection results of the external sensor device 40. Upon receiving a parking assistance start request from an occupant described later, the parking assistance control unit 100 starts parking assistance control by automatically operating the drive device 20, the steering device 21, the braking device 22, and the transmission device 23 based on the target travel route. The parking assistance control is executed, for example, by feedback-controlling operations of the drive device 20, the steering device 21, and the like based on a deviation between the target travel route and an actual travel trajectory of the vehicle VH. The actual travel trajectory of the vehicle VH may be calculated by odometry based on detection results of the vehicle speed sensor 31 and the steering angle sensor 34, or may be estimated based on optical flow or the like from image data of a road surface around the vehicle VH captured by the camera sensor 41.

While executing the parking assistance control, the parking assistance control unit 100 monitors, based on detection results of the external sensor device 40, whether there exists a surrounding object that may come into contact or collision with the vehicle VH. When a surrounding object having a high possibility of contact or collision is detected, the parking assistance control unit 100 interrupts the parking assistance control by decelerating the vehicle VH or stopping the vehicle VH. When the vehicle VH reaches a desired position within the parkable space and a shift position is switched to parking P, the parking assistance control unit 100 terminates the parking assistance control.

Incidentally, when a switch for receiving a parking assistance start request from an occupant (hereinafter referred to as a “use-start switch”) is configured as a visually conspicuous physical switch 63 (for example, a push-button type switch in which a light source is constantly turned on), an area around a driver's seat becomes visually cluttered. Therefore, it is conceivable to display the use-start switch on a touch-panel display 61 or to illuminate the use-start switch as a transparent switch 62. Even in such cases, in order to avoid being visually conspicuous at all times, it is conceivable to hide or turn off the use-start switch while it is not in use (that is, normally). However, when the use-start switch is displayed or illuminated using an occupant's operation (for example, an operation of bringing a hand close or touching a screen) as a trigger, there is a problem that the occupant has difficulty recognizing a position of the switch, thereby reducing operability.

In the present embodiment, the switch visualization processing unit 110 executes visualization processing to visualize the use-start switch at a timing when the parking assistance control unit 100 recognizes a parkable space, that is, at a timing when parking assistance becomes available. Hereinafter, details of the visualization processing will be described. In the following description, a timing when the parking assistance control unit 100 recognizes a parkable space is referred to as a “support-start-available timing.”

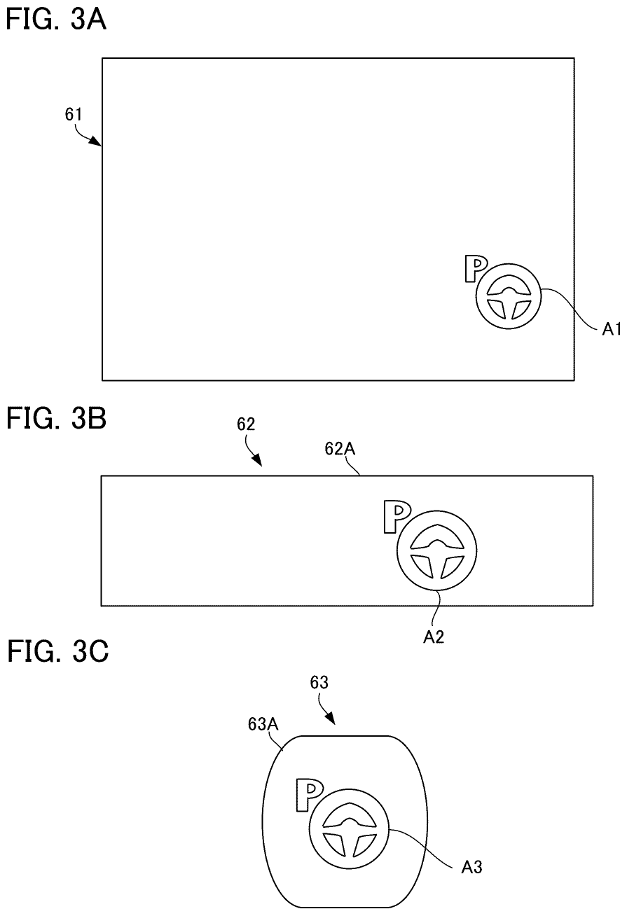

At the support-start-available timing, the switch visualization processing unit 110 visualizes the use-start switch in a mode as illustrated in FIG. 3. Specifically, as illustrated in FIG. 3A, when a touch-panel display 61 is used, the switch visualization processing unit 110 displays, on the display 61, a graphic A1 representing the use-start switch even if an occupant does not touch the display 61. Alternatively, as illustrated in FIG. 3B, when a transparent switch 62 is used, the switch visualization processing unit 110 displays, on a front side of a panel 62A, a graphic A2 representing the use-start switch by turning on a light source (not illustrated) on a rear side of the panel 62A, even if the occupant does not bring a hand close to the panel 62A. Alternatively, as illustrated in FIG. 3C, when a physical switch 63 is used, the switch visualization processing unit 110 causes a graphic A3 representing the use-start switch to be in a conspicuously light-emitting state by turning on a light source (not illustrated) on a rear side of the switch, even if the occupant does not press a button 63A of the physical switch 63.

As described above, by visualizing the use-start switch at the support-start-available timing, the occupant can easily recognize the position of the use-start switch. That is, it becomes possible to effectively prevent the occupant from touching other switch images on the display 61 or pressing other function switches of the transparent switch 62. As a result, operability of the use-start switch for parking assistance can be reliably improved. Further, before the support-start-available timing, the use-start switch is set to a hidden state or a turned-off state. That is, since the use-start switch is not visualized, it is possible to effectively suppress visual clutter around an instrument panel or a center console around a driver's seat, and it is also possible to reliably improve design aesthetics.

Note that a timing for hiding or turning off (de-visualizing) the use-start switch visualized by the visualization processing is not particularly limited. For example, the use-start switch may be hidden or turned off at any one of a timing when the occupant presses the use-start switch, a timing when the parking assistance control unit 100 starts the parking assistance control, or a timing when the parking assistance control unit 100 ends the parking assistance control.

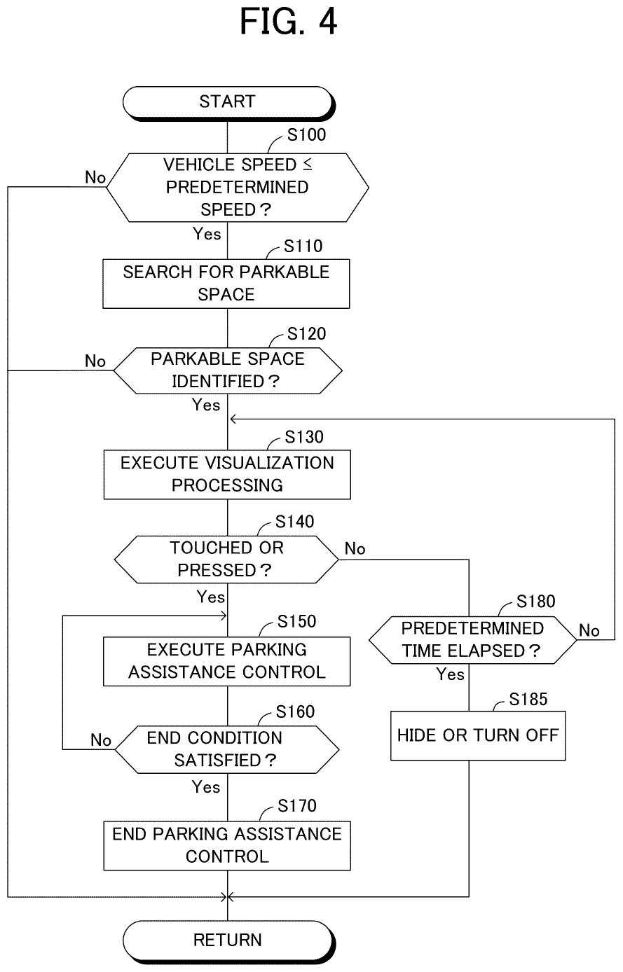

FIG. 4 is a flowchart for explaining a flow of parking assistance control and visualization processing of a use-start switch executed by the CPU 11 of the ECU 10. The routine illustrated in FIG. 4 is started, for example, when the vehicle VH begins traveling.

In step S100, the ECU 10 determines, based on a detection result of the vehicle speed sensor 31, whether a vehicle speed of the vehicle VH is equal to or less than a predetermined vehicle speed. When the vehicle speed is equal to or less than the predetermined vehicle speed (Yes), the ECU 10 proceeds to processing of step S110. On the other hand, when the vehicle speed is not equal to or less than the predetermined vehicle speed (No), that is, when the vehicle VH is traveling at a speed higher than the predetermined vehicle speed, the ECU 10 returns from the routine.

In step S110, the ECU 10 searches for a parkable space around the vehicle VH based on detection results of the external sensor device 40. Next, in step S120, the ECU 10 determines whether a parkable space has been recognized. When a parkable space has not been recognized (No), the ECU 10 returns from the routine. On the other hand, when a parkable space has been recognized (Yes), that is, when a support-start-available timing is reached, the ECU 10 proceeds to processing of step S130.

In step S130, the ECU 10 executes visualization processing to visualize the use-start switch by displaying or illuminating the use-start switch. Next, in step S140, the ECU 10 determines whether the visualized use-start switch has been touched or pressed by an occupant. When the use-start switch has been touched or pressed by the occupant (Yes), the ECU 10 proceeds to processing of step S150. On the other hand, when the use-start switch has not been touched or pressed by the occupant, the ECU 10 proceeds to processing of step S180.

In step S180, the ECU 10 determines whether an elapsed time from execution of the visualization processing in step S130 has reached a predetermined time (for example, several seconds). When the elapsed time has not reached the predetermined time (No), the ECU 10 returns to processing of step S130 and continues the visualization processing. On the other hand, when the elapsed time has reached the predetermined time (Yes), the ECU 10 proceeds to processing of step S185 to hide or turn off the use-start switch, and thereafter returns from the routine.

When processing proceeds from step S140 to step S150, the ECU 10 sets a target travel route and executes parking assistance control to automatically cause the vehicle VH to travel along the target travel route. Next, in step S160, the ECU 10 determines whether an end condition is satisfied in which the vehicle VH reaches a desired position within the parkable space and a shift position is switched to parking P. When the end condition is not satisfied (No), the ECU 10 returns to processing of step S150 and continues the parking assistance control. On the other hand, when the end condition is satisfied (Yes), the ECU 10 proceeds to processing of step S170 to terminate the parking assistance control, and thereafter returns from the routine.

As described above, the parking assistance apparatus according to the present embodiment has been described; however, the present disclosure is not limited to the above-described embodiment, and various modifications can be made without departing from the object of the present invention.

For example, in the above-described embodiment, the parking assistance control has been described as generating a target travel route; however, the technology of the present disclosure can also be applied to so-called route-memory-type parking assistance control. In such a case, visualization processing of the use-start switch may be executed when the vehicle VH approaches a registered parking location at or below a predetermined vehicle speed.

What is claimed is:

1. A parking assistance apparatus comprising
a control unit capable of executing parking assistance control that assists at least part of driving operations by parking a vehicle in a predetermined parking space,
the parking assistance apparatus comprising
a visualization processing unit configured to execute visualization processing that visualizes a use-start switch by displaying or illuminating the use-start switch for receiving a request from an occupant of the vehicle to start the parking assistance control,
wherein the visualization processing unit
visualizes the use-start switch by executing the visualization processing when the control unit recognizes, as the parking space, a parkable space in which the vehicle can be parked by the parking assistance control, and
does not visualize the use-start switch by hiding or turning off the use-start switch when the control unit does not recognize the parkable space.

2. The parking assistance apparatus according to claim 1,
wherein the use-start switch is a switch image displayed on a touch-panel display provided in a passenger compartment of the vehicle, and
wherein the visualization processing unit executes the visualization processing by displaying the switch image on the display.

3. The parking assistance apparatus according to claim 1,
wherein the use-start switch is a switch graphic displayed on a front side of a panel by turning on a light source from a rear side of a light-transmissive panel provided in a passenger compartment of the vehicle, and
wherein the visualization processing unit executes the visualization processing by turning on the light source to display the switch graphic on the front side of the panel.

4. The parking assistance apparatus according to claim 1,
wherein the use-start switch is a physical switch provided in a passenger compartment of the vehicle,
wherein the physical switch is configured to be capable of causing a predetermined graphic to emit light by turning on a light source on a rear side of the physical switch, and
wherein the visualization processing unit executes the visualization processing by turning on the light source to cause the graphic to emit light.
